(19) United States
(12) Patent Application Publication
(10) Pub. No.: US 2015/0185779 A1
(43) Pub. Date: Jul. 2, 2015

(54) SYSTEMS AND METHODS FOR REDUCING INPUT DEVICE NOISE

(71) Applicant: LENOVO (SINGAPORE) PTE. LTD., New Tech Park (SG)

(72) Inventors: Toshihisa Doi, Yokohama-shi (JP); Mitsuo Horiuchi, Sagamihara-shi (JP); Eiji Shinohara, Kawasaki-shi (JP)

(73) Assignee: LENOVO (SINGAPORE) PTE. LTD., New Tech Park (SG)

(21) Appl. No.: 14/140,602

(22) Filed: Dec. 26, 2013

(51) Int. Cl. G06F 1/16; G10K 11/00

(52) U.S. Cl. CPC G06F 1/1633; G10K 11/002; G06F 1/169; G06F 1/1679

(57) ABSTRACT

Stabilizing systems are disclosed herein that can reduce the amount of noise produced by an input device and can contribute to a stable feeling in operation even with a short pushing stroke. In some embodiments, a stabilizer bar is coupled to a base plate by hooks with semi-circular cut-outs that allow the stabilizer bar to slide and tilt relative to the base plate. The stabilizer bar is also coupled to an input element by hooks having semi-circular cut-outs and a spring tab that allow the stabilizer bar to rotate relative to the input element. Bias forces generated by the spring tabs and the tension in the stabilizer bar maintain the bar in firm engagement with the hooks, preventing collisions and clattering noises during operation.

### FIELD

Systems and methods are disclosed herein that generally relate to reducing input device noise and in particular to reducing clattering noise produced by keyboard keys, buttons, clickable touchpads, and so forth.

### BACKGROUND

Input devices of various types can produce clattering and other noises during operation that can be distracting or irritating to the user or persons nearby. For example, many computer systems include keyboard keys, buttons, clickable touchpads, or other input elements that are pushed by a user to provide input to the computer system. These devices often include a stabilizer to keep the input element level as it is pushed by the user. Existing stabilizers are retained by hooks that leave a gap between the stabilizer and the hook for tolerance purposes and to allow the stabilizer to release when the device is actuated. The stabilizer can collide with the hook during operation, producing an undesirable clattering noise.

A need exists for improved input devices, and in particular for systems and methods for reducing input device noise.

### SUMMARY

Stabilizing systems are disclosed herein that can reduce the amount of noise produced by an input device and can contribute to a stable feeling in operation even with a short pushing stroke. In some embodiments, a stabilizer bar is coupled to a base plate by hooks with semi-circular cut-outs that allow the stabilizer bar to slide and tilt relative to the base plate. The stabilizer bar is also coupled to an input element by hooks having semi-circular cut-outs and a spring tab that allow the stabilizer bar to rotate relative to the input element. Bias forces generated by the spring tabs and the tension in the stabilizer bar maintain the bar in firm engagement with the hooks, preventing collisions and clattering noises during operation.

In some embodiments, a stabilizing system for reducing noise in an input device having a base plate and an input element includes a stabilizer bar having an elongate central portion and first and second leg portions extending from opposed ends of the central portion, the stabilizer bar being disposed beneath the input element. The system also includes a first lower hook extending upwards from the base plate having a first cut-out in which the first leg portion of the stabilizer bar is slidably received, and a second lower hook extending upwards from the base plate having a second cut-out in which the second leg portion of the stabilizer bar is slidably received. The stabilizer bar is configured to squeeze the first and second leg portions into engagement with the first and second cut-outs.

In some embodiments, a laptop computer system includes a plurality of stabilizing systems coupled between a clickable touchpad housing and a base plate. Each stabilizing system includes a stabilizer bar having an elongate central portion and first and second leg portions extending from opposed ends of the central portion, a first lower hook extending upwards from the base plate having a first cut-out in which the first leg portion of the stabilizer bar is slidably received, and a second lower hook extending upwards from the base plate having a second cut-out in which the second leg portion of the stabilizer bar is slidably received, the stabilizer bar being configured to squeeze the first and second leg portions into engagement with the first and second cut-outs. Each stabilizing system also includes a first upper hook extending downwards from the housing having a third cut-out in which the central portion of the stabilizer bar is rotatably received, a first spring tab configured to urge the central portion of the stabilizer bar into engagement with the third cut-out, a second upper hook extending downwards from the housing having a fourth cut-out in which the central portion of the stabilizer bar is rotatably received, and a second spring tab configured to urge the central portion of the stabilizer bar into engagement with the fourth cut-out.

In some embodiments, a method of actuating an input device having a base plate, an input element, and a stabilizer bar includes depressing the input element and, during said depressing, rotating a central portion of the stabilizer bar within a semi-circular cut-out formed in an upper hook that extends down from the bottom of the input element. The method also includes, during said rotating, sliding first and second leg portions of the stabilizer bar within respective first and second semi-circular cut-outs formed in respective first and second lower hooks extending up from the base plate, the first and second leg portions being biased into engagement with the first and second cut-outs.

The present invention further provides devices, systems, and methods as claimed.

### BRIEF DESCRIPTION OF THE DRAWINGS

The invention will be more fully understood from the following detailed description taken in conjunction with the accompanying drawings, in which:

FIG. 1A is a perspective view of an exemplary laptop computer system.

FIG. 1B a top view of the lower housing of the laptop computer system of FIG. 1A.

FIG. 1C is a sectional side view of the clickable touchpad of the laptop computer system of FIG. 1A.

FIG. 1D is a top view of the clickable touchpad of FIG. 1C.

FIG. 2A is a sectional side view of an input element without a stabilizer.

FIG. 2B is a sectional side view of an input element with a stabilizer.

FIG. 2C is a perspective top view of a base plate with a stabilizer rotatably supported in a hook.

FIG. 2D is a schematic side view of a stabilizer disposed between a base plate and an input element.

FIG. 2E is a sectional side view of the hook of FIG. 2C.

FIG. 2F is a sectional side view of the connection between the stabilizer of FIG. 2C and the input element.

FIG. 3A is a perspective exploded view of an input device having a base plate, an input element, and an exemplary embodiment of a stabilizing system.

FIG. 3B is a perspective view from above of the base plate of FIG. 3A.

FIG. 3C is a perspective view from below of the input element of FIG. 3A.

FIG. 4A is a perspective view of a lower hook of the stabilizing system of FIG. 3A.

FIG. 4B is a top view of a stabilizer bar and associated lower hooks of the stabilizing system of FIG. 3A.

FIG. 4C is a perspective view of first and second stabilizer bars and associated lower hooks of the stabilizing system of FIG. 3A.

FIG. 4D is a schematic depiction of stabilizer bar movement in the stabilizing system of FIG. 3A.

FIG. 5A is a perspective view of first and second stabilizer bars and associated upper hooks of the stabilizing system of FIG. 3A.

FIG. 5B is a sectional side view of a stabilizer bar and an associated upper hook of the stabilizing system of FIG. 3A.

FIG. 5C is a bottom view of first and second stabilizer bars and associated upper hooks of the stabilizing system of FIG. 3A.

FIG. 5D is a side view of the assembled stabilizing system of FIG. 3A.

FIG. 6A depicts the base plate of FIG. 3A from above and the input element of FIG. 3A from below.

FIG. 6B is a side view of a coupling system of the input device of FIG. 3A.

FIG. 6C is a perspective view of the coupling system of FIG. 6B.

### DETAILED DESCRIPTION

Stabilizing systems are disclosed herein that can reduce the amount of noise produced by an input device and can contribute to a stable feeling in operation even with a short pushing stroke. In some embodiments, a stabilizer bar is coupled to a base plate by hooks with semi-circular cut-outs that allow the stabilizer bar to slide and tilt relative to the base plate. The stabilizer bar is also coupled to an input element by hooks having semi-circular cut-outs and a spring tab that allow the stabilizer bar to rotate relative to the input element. Bias forces generated by the spring tabs and the tension in the stabilizer bar maintain the bar in firm engagement with the hooks, preventing collisions and clattering noises during operation.

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

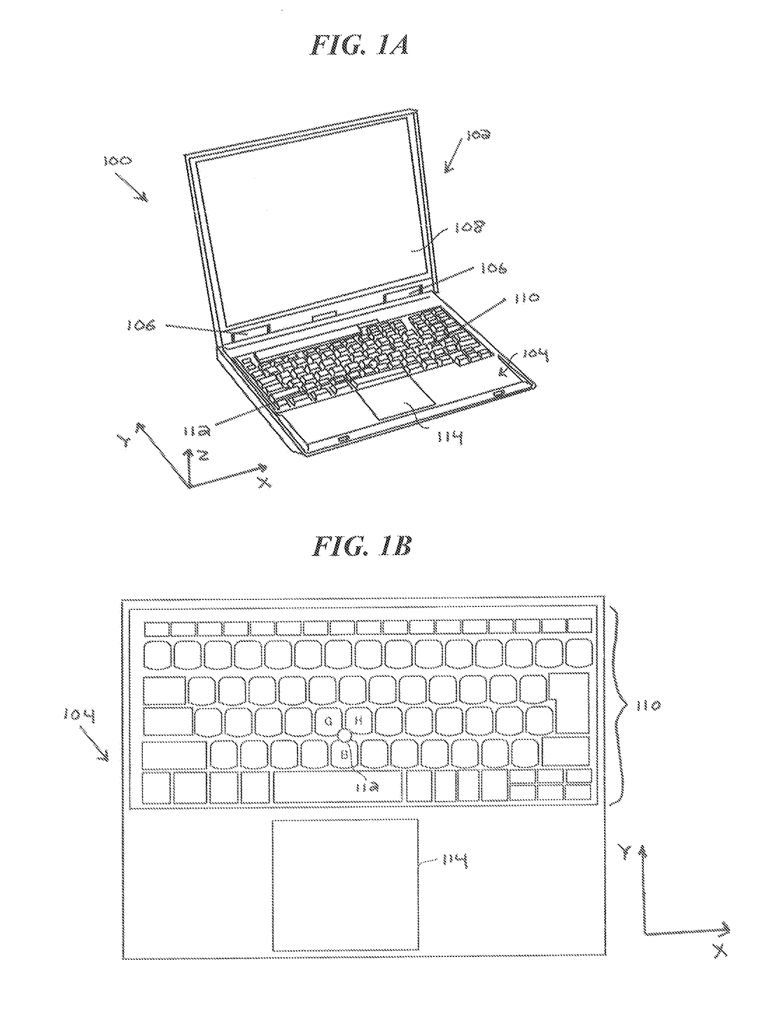

FIGS. 1A-1D illustrate an exemplary embodiment of a laptop computer system 100. The computer system 100 generally includes an upper housing 102 and a lower housing 104 coupled to one another by one or more hinges 106. As is well known in the art, the computer system 100 can include processing, memory, storage, networking, and other systems for executing programs, storing data, communicating with other computer systems, and so forth. The upper housing 102 includes an electronic display 108 for displaying information to a user. The lower housing 104 includes one or more input devices for receiving input from the user. In the illustrated embodiment, the input devices include a keyboard 110, a pointing stick 112, and a clickable touchpad 114, though it will be appreciated that other input devices can be included instead or in addition. An exemplary clickable touchpad is the CLICKPAD available from SYNAPTICS, INC.

Each of the keys of the keyboard 110 is individually movable in the Z direction relative to the lower housing 104 and is supported above a sensor or mechanical switch configured to detect movement of the key in the Z direction. When a key is depressed in the Z direction by a user, the movement is detected and translated into an input action, such as user entry of navigation commands, text, or other characters. When the user releases the key, the key returns to a non-depressed resting position. In some embodiments, an elastic support member such as a rubber dome returns the key to the resting position.

As shown in FIG. 1C, the clickable touchpad 114 is similarly movable in the Z direction relative to the lower housing 104 and is supported above one or more sensors or mechanical switches 116 configured to detect movement of the clickable touchpad in the Z direction. As shown in FIG. 1D, one or more pseudo button areas 118 are logically and/or physically defined on the top surface of the clickable touchpad 114. In use, a mouse click or other input action can be emulated by the user placing a finger on a pseudo button area 118 and depressing the clickable touchpad 114 in the Z direction. A processor, device driver, or other component of the computer system 100 receives the clickable touchpad surface coordinates at which the user's finger is placed at the time that a click event is detected by the sensor 116, and determines from this information which pseudo button 118, if any, the user clicked. If a pseudo button 118 is clicked, an action associated with that button (e.g., a left mouse click, a right mouse click, etc.) is executed. The Z-movement that occurs when a user clicks a pseudo button 118 advantageously provides tactile feedback to the user. When the user releases the clickable touchpad, it returns to a non-depressed resting position. In some embodiments, an elastic support member such as a rubber dome returns the clickable touchpad to the resting position. The clickable touchpad 114 is also capable of receiving various non-clicking user inputs, such as taps, drags, swipes, and other gestures performed on the surface of the clickable touchpad.

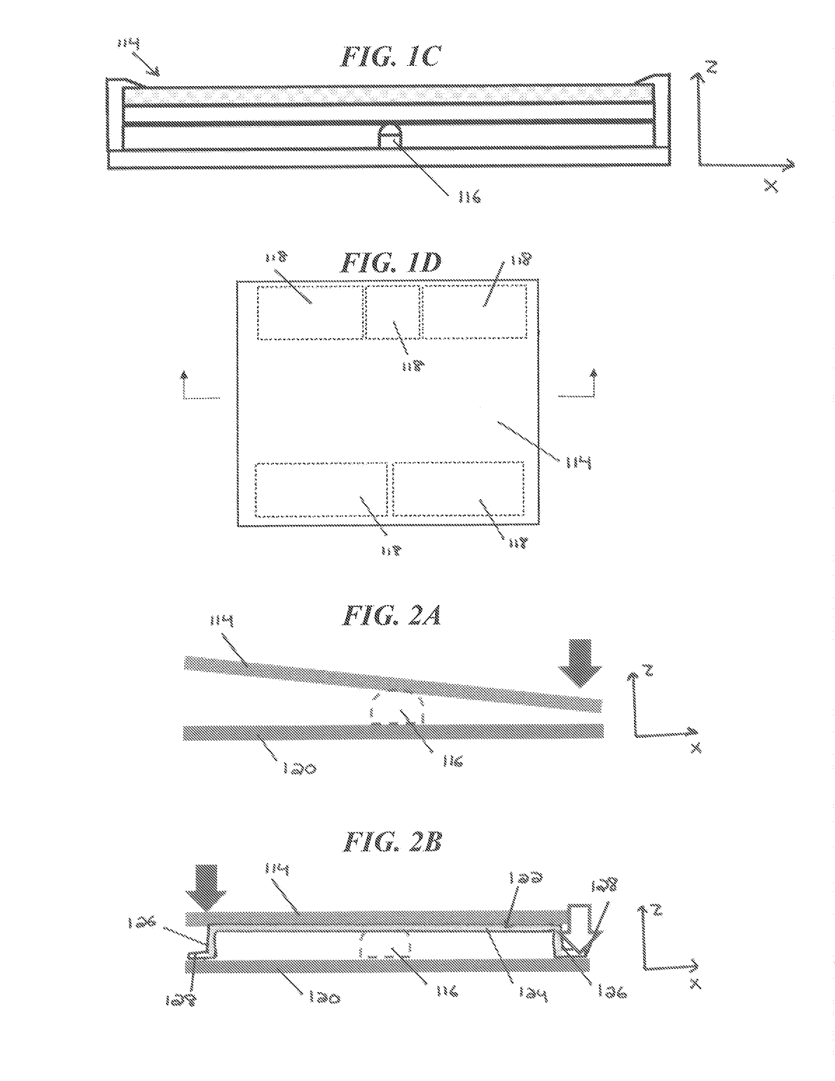

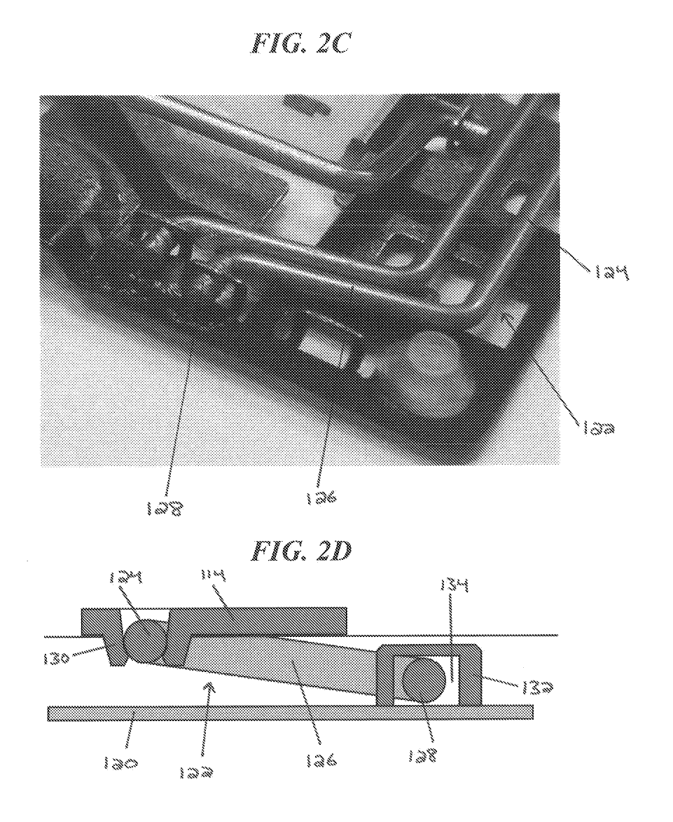

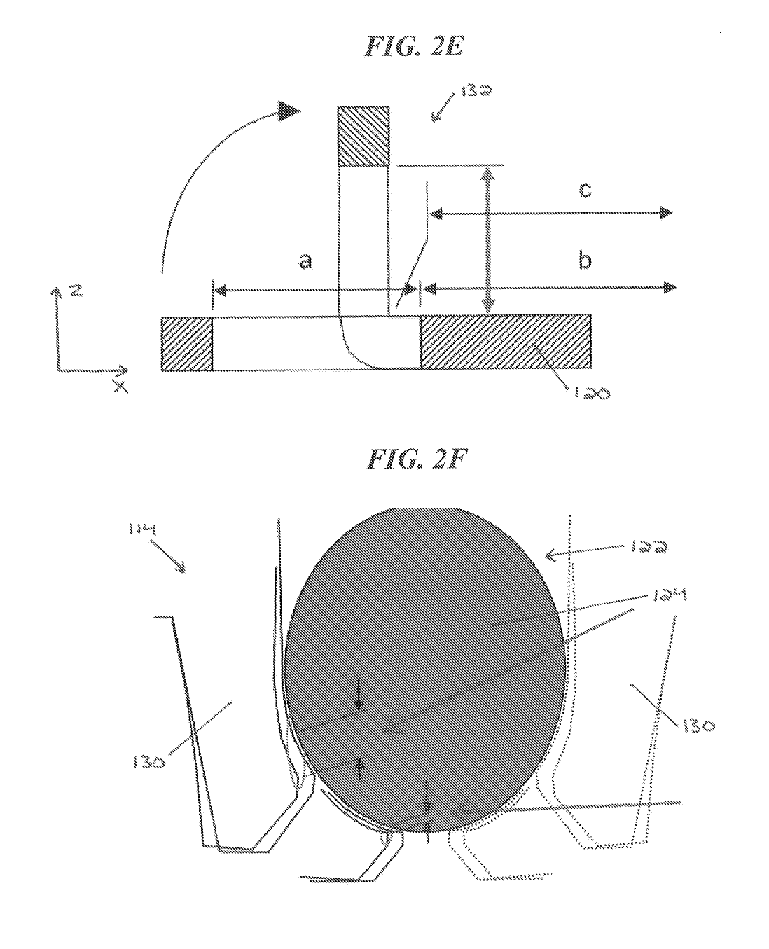

As shown in FIG. 2A, when an input element 114 (e.g., a keyboard key, a button, a clickable touchpad housing, etc.) is relatively large in the X and/or Y dimensions, the sensor 116 can act as a fulcrum when a force is applied away from the center of the element, causing the element to tilt or be depressed unevenly towards the base plate 120. This can occur even when a plurality of sensors 116 are disposed beneath the element 114. As a result, a seesaw effect occurs and the corner of the element 114 can contact the base plate 120 beneath, diminishing the “feel” of the input element's operation for the user. As shown in FIG. 2B, this phenomenon can be reduced or prevented by including a stabilizer 122 between the element 114 and the base plate 120 to distribute the forces applied to the element. This propagates the pushing force to an opposite end of the element 114, such that the element is pushed down equally and horizontally-level. The illustrated stabilizer 122 is a bar that includes an elongate central portion 124 that extends in either the X or Y direction and supports the element 114. As shown in FIGS. 2B and 2C, the bar 122 is bent 90 degrees at each end of the central portion 124 to form a leg portion 126, which is bent 90 degrees to form a foot portion 128.

Attachment of the stabilizer 122 is shown schematically in FIG. 2D. As shown, the elongate central portion 124 is rotatably supported between one or more pairs of resilient tabs 130 that extend down from the underside of the input element 114. The foot portion 128 of the stabilizer 122 is rotatably supported in a hook 132 formed in the base plate 120. The hook 132 extends in a direction perpendicular to the longitudinal axis of the central portion 124 of the stabilizer bar 122.

Stabilizers of the type shown in FIGS. 2A-2F suffer from a number of disadvantages. For example, the input element 114 or the stabilizer 122 can produce a clattering noise when actuated by user, which can be irritating for the user or others who are nearby. In particular, a gap 134 must be provided in at least one of the coupling between the stabilizer 122 and the element 114 and the coupling between the stabilizer 122 and the base plate 120 to allow the stabilizer to move in the X or Y direction when the element is depressed in the Z-direction. Specifically, as shown in FIG. 2D, the leg portion 126 has a fixed length, so when the element 114 is depressed in the Z-direction, the foot portion 128 slides to the right, within the gap 134 provided in the hook 132. The play that exists between the stabilizer 122 and the hook 132 in the gap 134 generates a clattering noise when the element 114 is actuated, since the stabilizer moves in the gap and collides with the hook. The height of the gap 134 is sized with a tolerance to prevent sticking, so the stabilizer foot 128 can also move up and down within the gap in the Z direction slightly which contributes to the clattering noise. Grease can be applied to the connection between the stabilizer 122 and the hook 132 in an effort to reduce the clattering noise, however this is typically insufficient to adequately reduce the clattering and the grease tends to smear and create quality problems.

In addition, as shown in FIG. 2E, the hook 132 is typically formed by pressing or punching the base plate 120 and bending up the hook, which subjects the dimensions of the gap to at least three different design and/or manufacturing tolerances. For example, the following parameters contribute to the overall tolerance: (a) the size of the punch hole, (b) the X, Y location where the punch is formed, and (c) the X, Y position where the bend is formed. Accordingly, the tolerance accumulates through the manufacturing process, introducing up-down and left-right stabilizer play that makes the clattering noise worse.

Similar tolerance issues exist at the coupling between the stabilizer 122 and the element 114. As shown in FIG. 2F, the tabs 130 that support the central portion 124 of the stabilizer can flex or deform, allowing undesirable movement of the central portion in the X, Y, and/or Z directions. In addition, the tabs 130 have a relatively high profile, which increases the minimum Z direction gap between the element 114 and the base plate 120.

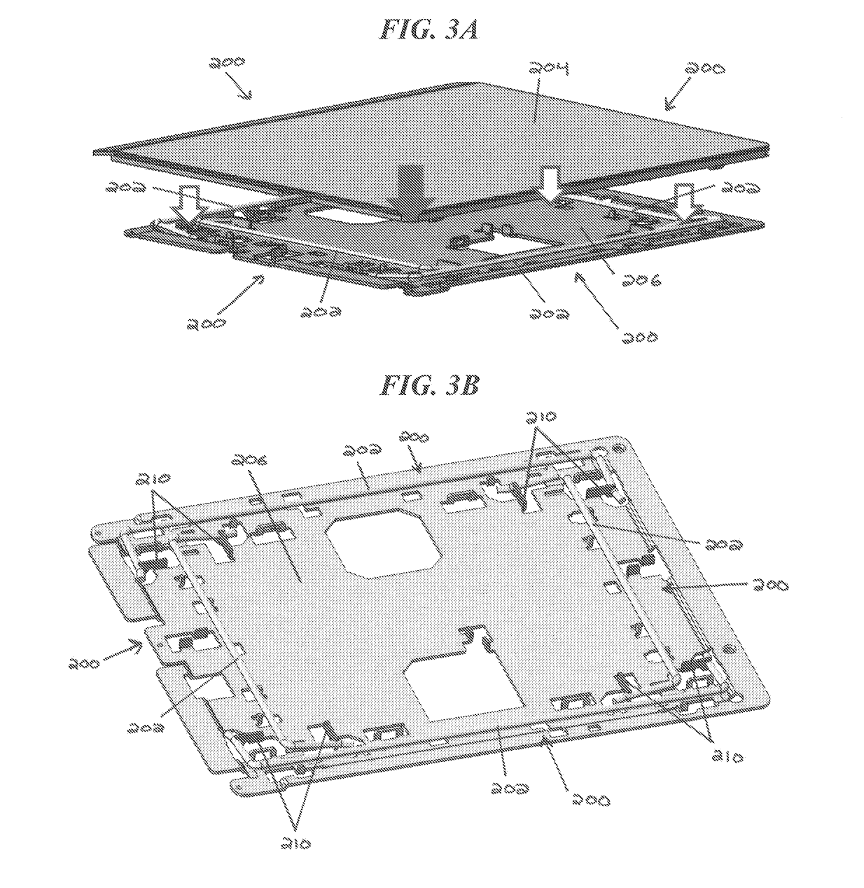

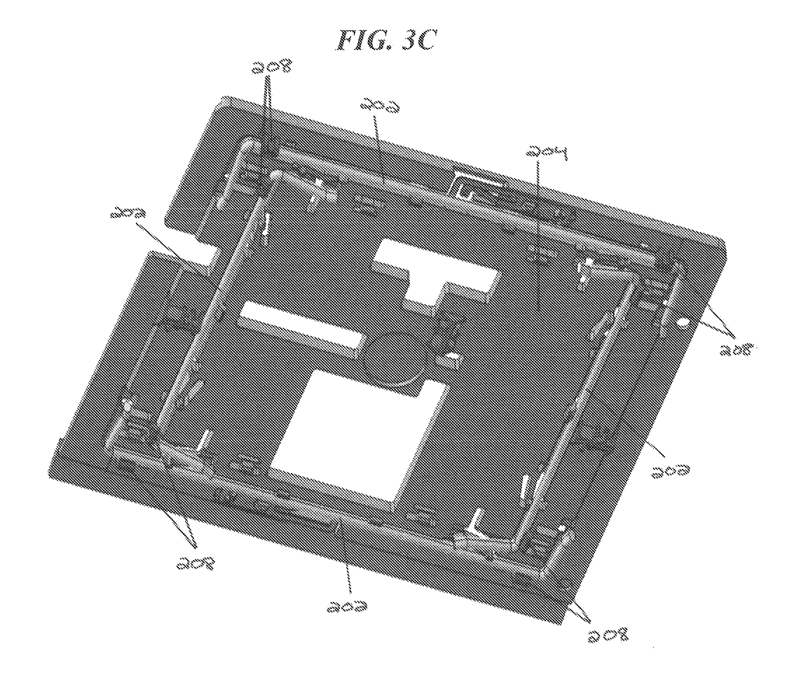

FIGS. 3A-3C illustrate an exemplary embodiment of a reduced-noise stabilizing system 200. While the stabilizing system is shown in a clickable touchpad application, it will be appreciated that the system 200 can be readily used with various other input devices including, without limitation, keyboard keys, buttons, enter keys, space keys, shift keys, backspace keys, and the like. In addition, while a laptop computer system is generally shown and described herein, it will be appreciated that the system 200 can be used with any device that includes an input element (e.g., a key, a button, a clickable touchpad, etc.) including, without limitation, mobile devices, cellular phones, tablet computers, desktop computers, computer peripherals, digital cameras, printers, and so forth.

The stabilizing system 200 includes a stabilizer bar 202 extending between the input element 204 (in this case, a clickable touchpad housing) and a base plate 206. The stabilizer bar 202 is coupled to one or more upper hooks 208 (see FIG. 3C) attached to or formed on the input element 204 and one or more lower hooks 210 (see FIG. 3B) attached to or formed on the base plate 206. In the illustrated embodiment, the stabilizer bar 202 is coupled to the input element 204 by first and second upper hooks 208 and to the base plate 206 by first and second lower hooks 210. An input element can include one or more stabilizing systems 200. The illustrated embodiment includes four stabilizing systems. Two stabilizer bars 202 extend primarily in the X direction and two stabilizer bars 202 extend primarily in the Y direction, such that each edge of the input element 204 is supported by a stabilizer bar that extends parallel to said edge. It will be appreciated, however, that any number of stabilizer bars 202 can be provided (e.g., 1, 2, 3, or 5+) and that that stabilizer bars can extend in any direction or any combination of directions. For example, a space key on a keyboard can be supported by a single bar that extends in the X direction or first and second bars that extend in the X direction.

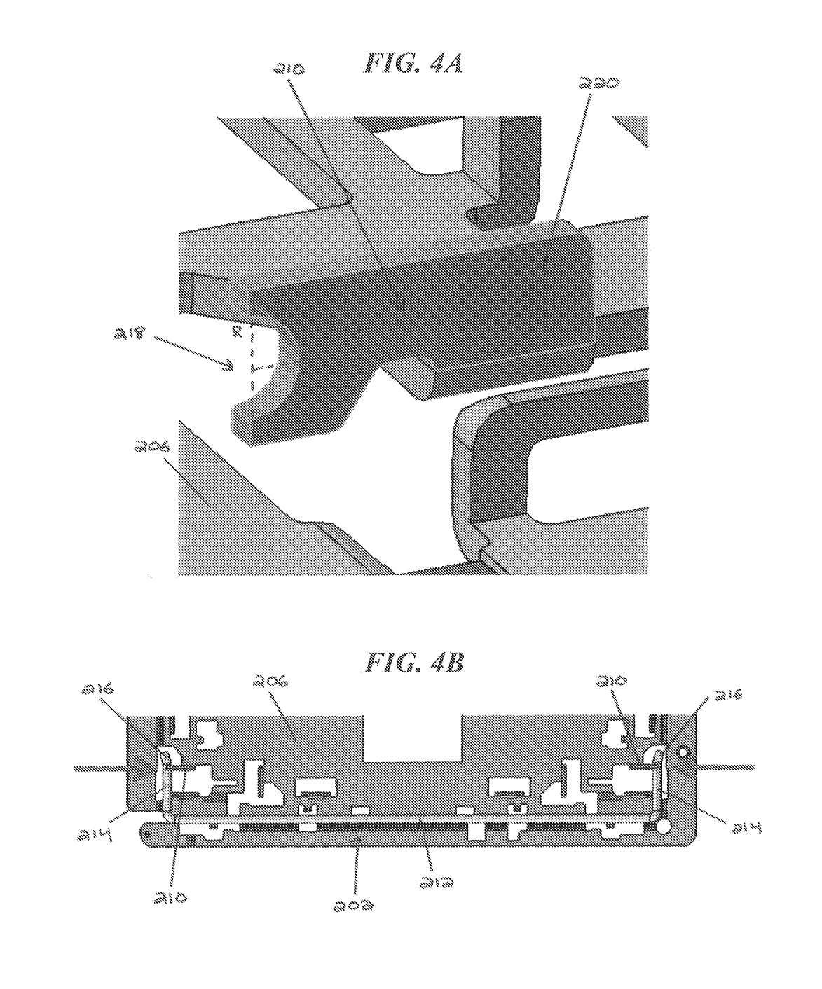

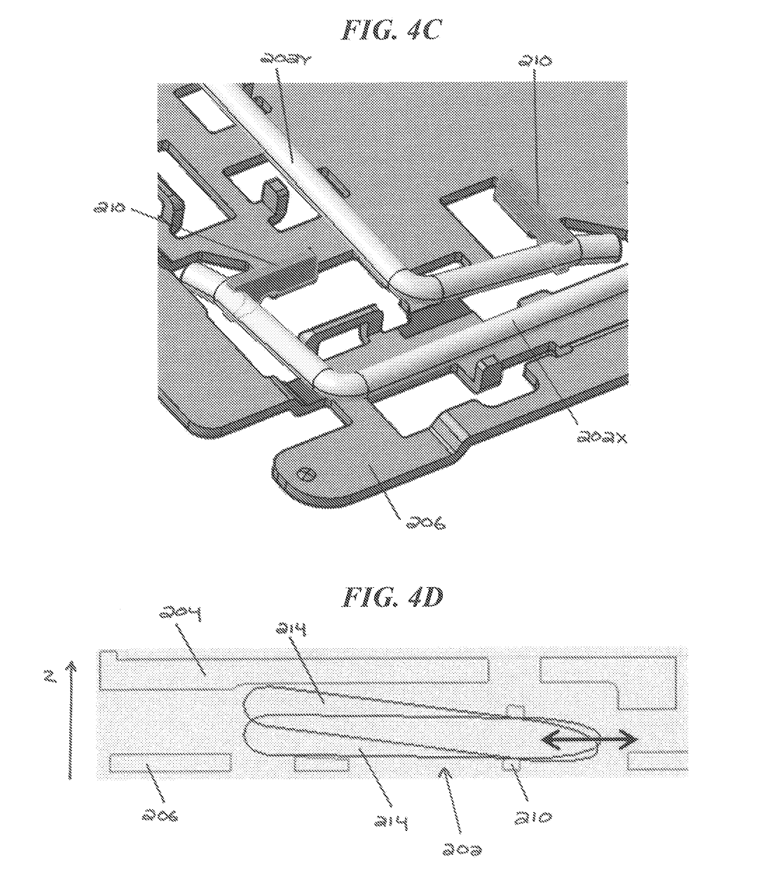

FIGS. 4A-4D illustrate the stabilizer bar 202 attachment to the base plate 206 in more detail. As shown, each stabilizer bar 202 includes an elongated central portion 212 with 90 degree bends at each end to form first and second leg portions 214. The free end of each leg portion 214 can include another bend to form a foot portion 216. The foot portion 216 can extend at an oblique angle from the longitudinal axis of the leg portion 214.

The lower hooks 210 extend upwards from the base plate 206 and include a cut-out or recess 218 that receives the leg portion 214 of the stabilizer bar 202. In the illustrated embodiment, the lower hook 210 includes a rectangular body portion 220 that extends upwards from the base plate 206 at a 90 degree angle. The rectangular body portion 220 extends in a direction that is parallel to the longitudinal axis of the central portion 212 of the stabilizer bar 202 coupled thereto. The cut-out 218 is formed in the edge of the body portion 220 that faces the leg portion 214 of the stabilizer bar 202. In other words, the cut-out 218 is an open cut-out. The illustrated cut-out 218 is semi-circular and extends approximately 180 degrees around the circumference of the stabilizer bar 202. It will be appreciated however that the cut-out 218 can have various other shapes and configurations. For example, the cut-out 218 can be non-circular, and/or can extend around more or less than 180 degrees of the stabilizer bar 202. In an exemplary embodiment, the radius R of the cut-out portion 218 can be about equal to or slightly greater than the radius of the stabilizer bar 202. For example, the cut-out and the stabilizer bar can each have a radius of about 0.625 mm.

In some embodiments, one or more of the lower hooks 210 can be formed by punching the base plate 206 with a die that is substantially a negative of the hook and then bending the hook upwards from the base plate until the body portion 220 is perpendicular to the base plate. Alternatively, or in addition, one or more of the lower hooks 210 can be separate from the base plate 206 and can be glued, welded, bolted, or otherwise attached to the base plate.

As shown in FIG. 4B, the lower hooks 210 can be formed in pairs for receiving a single stabilizer bar 202. The pair of lower hooks 210 can be disposed along an axis that extends parallel to the edge of the input element 204, and/or parallel to the longitudinal axis of the central portion 212 of the stabilizer bar 202. The lower hooks 210 can be formed such that the cut-out portions 218 thereof are oriented away from each other, towards the periphery of the input element 204. The relative positioning of the lower hooks 210 and the length of the stabilizer bar central portion 212 (i.e., the length between leg portions 214) is selected such that the leg portions 214 are deflected outward slightly when the stabilizer bar is coupled to the lower hooks 210. Resilient properties of the material used to form the stabilizer bar 202 thus cause the leg portions 214 to squeeze inwards in the direction of the illustrated arrows into firm engagement with the cut-out portions 218 of the lower hooks 210, such that the stabilizer bar catches the lower hooks like a clip. This constant force helps retain the stabilizer bar 202 in the lower hooks 210 and reduces the tendency for a clattering noise to be generated when the stabilizer bar moves relative to the hooks. In particular, gaps in the coupling between the stabilizer bar 202 and the base plate 206 can be substantially eliminated in the system 200, thus preventing collisions and associated noise when the system 200 is actuated. The slight bend leading into the foot portions 216 of the stabilizer bar 202 can help retain the stabilizer bar in the lower hooks 210 and provide stability when the input element 204 is disposed in a non-depressed position.

FIG. 4C provides a close-up view of lower hooks 210 associated with a first stabilizer bar 202X that extends in the X direction along one edge of the input element 204 and a second stabilizer bar 202Y that extends in the Y direction along another edge of the input element.

FIG. 4D schematically illustrates a stabilizer bar 202 when the input element 204 is in a first, non-depressed position and a second, depressed position. As indicated by the illustrated arrow, the leg portion 214 slides in the X or Y direction (depending on the orientation of the stabilizer) relative to the lower hooks 210 when the input element 204 is transitioned between the first and second positions. In particular, when the input element 204 is pushed down to the second position, the leg portion 214 translates in a generally longitudinal direction to the right in the illustration. When the input element 204 is allowed to rise back to the first position, the leg portion 214 translates in a generally longitudinal direction to the left in the illustration. In an exemplary embodiment, the total travel of the input element 204 between the first position and the second position is between about 1 mm and about 2 mm, and the leg portions 214 of the stabilizer bar 202 slide in the X or Y direction approximately 0.05 mm during said travel. The stabilizing system 200 thus uses a combination of sliding and tilting movements, in contrast to the mechanism of FIGS. 2A-2F in which rotational movement about an axle occurs. The sliding and tilting movement of the system 200 has a reduced tendency to generate collision-related noise as compared with the axle rotation movement of the system shown in FIGS. 2A-2F.

Also, in contrast with the hooks 132 of FIGS. 2A-2F, the lower hooks 210 of FIGS. 4A-4C do not accumulate tolerance. In particular, the only tolerance that is important with the lower hooks 210 of FIGS. 4A-4C is the size of the cut-out portions 218. The X, Y position where the punch is formed and the X, Y position where the bend is formed are relatively unimportant, since the spring force and sliding range of the stabilizer bar 202 can compensate for any error. The lower hooks 210 are thus subject to only a single tolerance parameter, whereas the hooks 132 accumulate tolerance across three parameters. This allows the overall tolerance to be reduced in the system 200, which in turn reduces or prevents collisions and associated clattering noises.

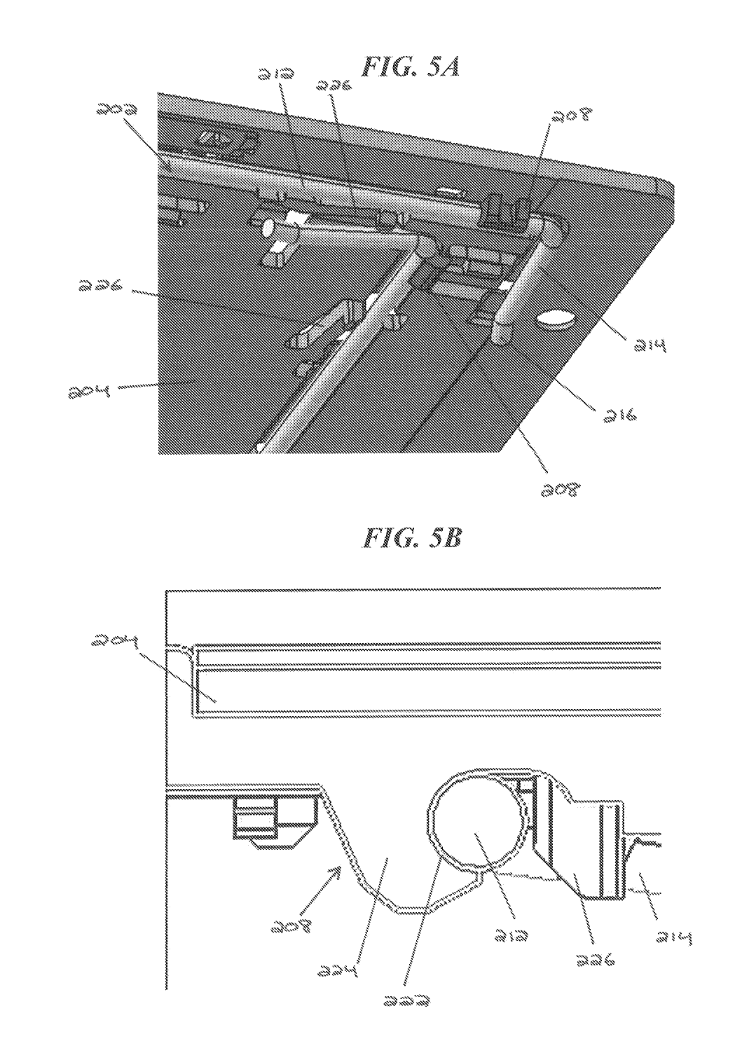

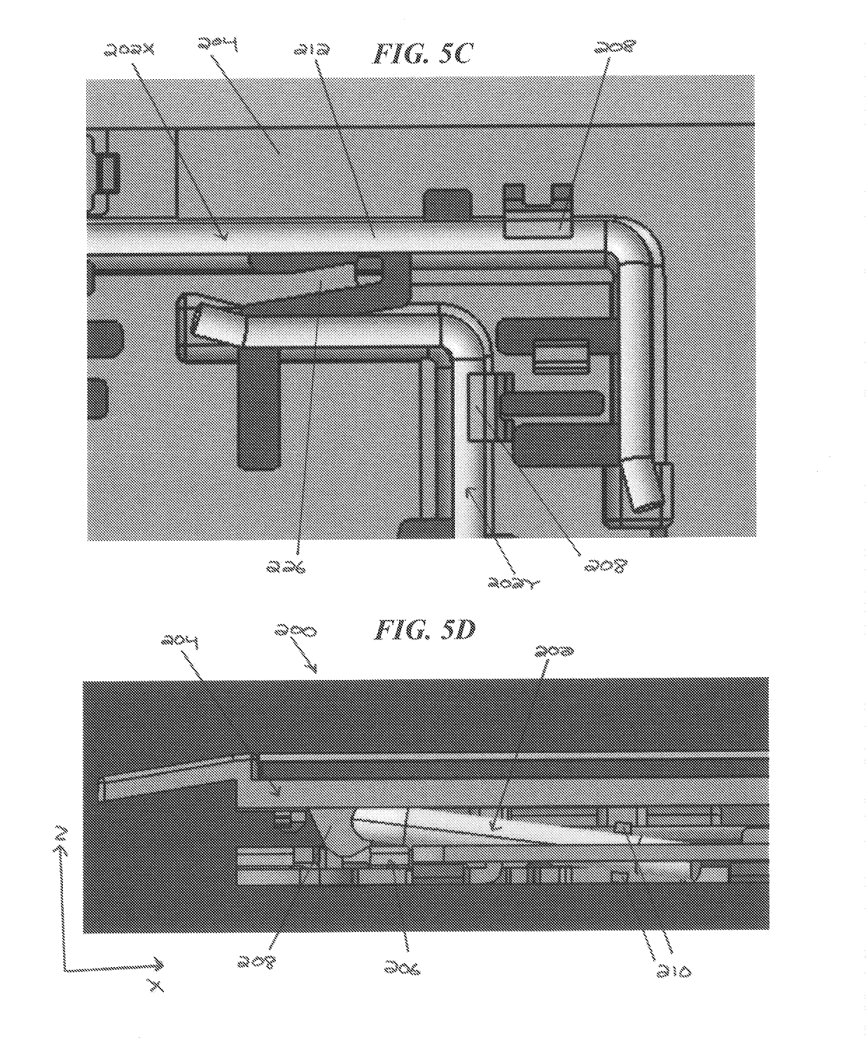

FIGS. 5A-5D illustrate the stabilizer bar 202 attachment to the input element 204 (in this case, a clickable touchpad housing) in more detail. As shown, the upper hooks 208 extend downwards from the input element 204 and include a cut-out or recess 222 that receives the central portion 212 of the stabilizer bar 202. In the illustrated embodiment, the upper hook 208 includes a body portion 224 that extends downwards from the input element 204. The cut-out 222 is formed in the edge of the body portion 224 that faces the stabilizer bar 202. The illustrated cut-out 222 is semi-circular and extends approximately 180 degrees around the circumference of the stabilizer bar 202. It will be appreciated however that the cut-out 222 can have various other shapes and configurations. For example, the cut-out 222 can be non-circular, and/or can extend around more or less than 180 degrees of the stabilizer bar 202. The upper hooks 208 can extend in a direction that is parallel to the longitudinal axis of the central portion 212 of the stabilizer bar 202 to which they are coupled. In some embodiments, one or more of the upper hooks 208 can be formed by punching the input element 204 with a die that is substantially a negative of the hook 208 and then bending the hook downwards from the input element. Alternatively, or in addition, one or more of the upper hooks 208 can separate from the input element 204 and can be glued, welded, bolted or otherwise attached to the input element.

The stabilizer bars 202 are also secured to the input element 204 by one or more spring tabs 226. In particular, the spring tabs 226 engage a side of the stabilizer bar 202 opposite to the side that is engaged by the upper hooks 208, and the bias force of the spring tab urges the stabilizer bar into firm engagement with the upper hooks. In other words, the central portion 212 of the stabilizer bar 202 is constantly squeezed between the spring tabs 226 and the upper hooks 208. This can help secure the stabilizer bar 202 to the upper hooks 208 and reduce clattering noise during actuation of the input element 204. In the illustrated embodiment, each upper hook 208 is accompanied by a corresponding spring tab 226. In other embodiments, additional or fewer spring tabs 226 can be included. The spring tabs 226 can be formed by molding (e.g., in the case of a resin input element) or by punching (e.g., in the case of a metal input element) the input element 204 in a position that interferes with the normal position of the stabilizer bar 202, such that the spring tab is deflected slightly when the stabilizer bar is installed and therefore the resilient properties of the spring tab exert a squeezing force on the stabilizer bar. While a cantilevered leaf spring is shown, the spring tabs 226 can have any structure that urges the stabilizer bar 202 into engagement with the upper hooks 208.

As shown in FIG. 3C, the upper hooks 208 can be formed in pairs for receiving a single stabilizer bar 202. The upper hooks 208 can be disposed along an axis that extends parallel to the edge of the input element 204, and/or parallel to the longitudinal axis of the central portion 212 of the stabilizer bar 202.

FIG. 5C provides a close-up view of upper hooks 208 associated with a first stabilizer bar 202X that extends in the X direction along one edge of the input element 204 and a second stabilizer 202Y bar that extends in the Y direction along another edge of the input element.

FIG. 5D shows a stabilizer bar 202, the input element 204, and the base plate 206 when the stabilizing system 200 is fully assembled. As will be appreciated, the upper hook 208 maintains the central portion of the stabilizer bar 202 in a substantially fixed X, Y position as the input element 204 moves back and forth between the first, non-depressed position and the second, depressed position. The lower hook 210, on the other hand, allows the stabilizer bar 202 to slide slightly in the X or Y direction as the input element 204 is actuated.

In contrast with the hooks 132 of FIGS. 2A-2F, the upper hooks 208 of FIGS. 5A-5D do not accumulate tolerance. In particular, the only tolerance that is important with the upper hooks 208 of FIGS. 5A-5C is the size of the cut-out portions 222. The X, Y position where the hooks 208 are formed (e.g., by molding or punching) is relatively unimportant, since the spring force of the leaf springs 226 and the length of the central portion 212 of the stabilizer bar 202 can compensate for any error. The upper hooks 208 are thus subject to only a single tolerance parameter, whereas the hooks 132 accumulate tolerance across three parameters. In addition, the upper hooks 208 do not allow as much X, Y, and/or Z movement of the stabilizer bar 202 as the resilient tabs 130 of FIGS. 2A-2F. The design of the upper hooks 208 thus reduces the overall tolerance in the system 200 which in turn reduces or prevents collisions during actuation and noise associated therewith.

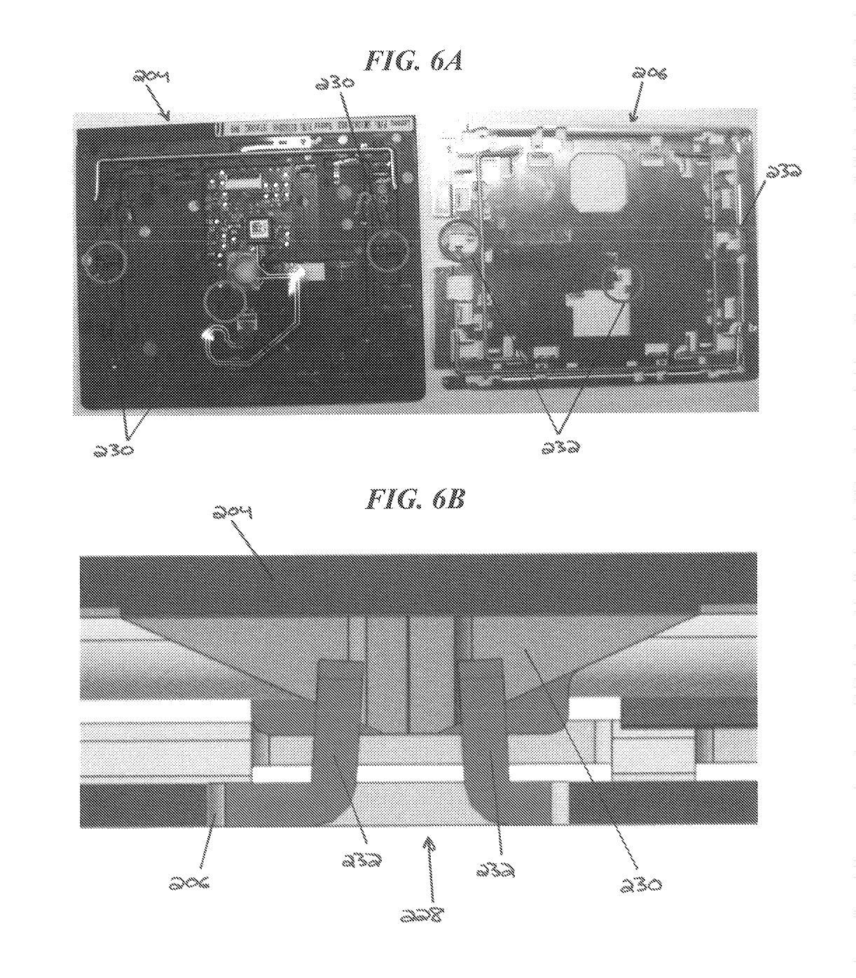

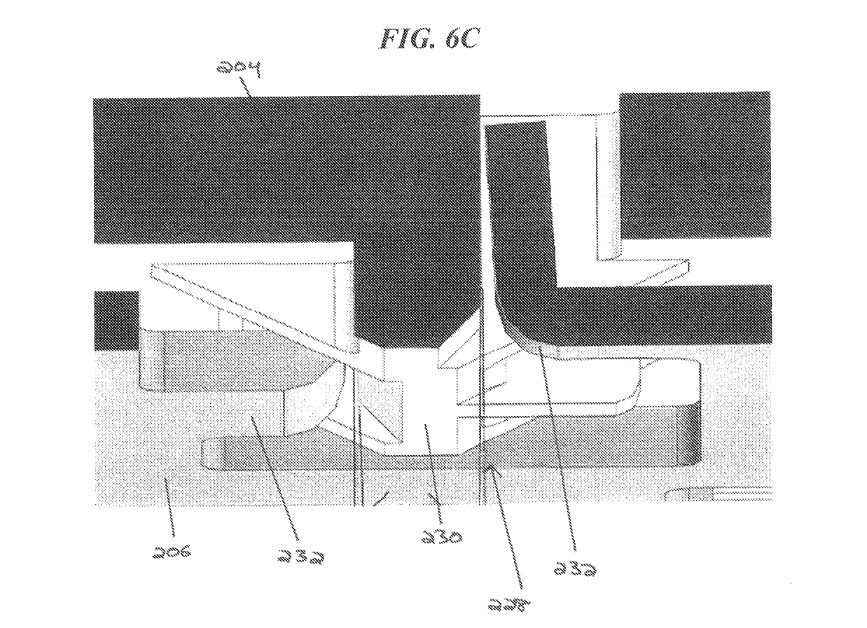

As shown in FIGS. 6A-6C, the X, Y position of the input element 204 is substantially fixed relative to the base plate 206 by a coupling or XY keeping mechanism 228. The coupling mechanism 228 includes one or more tabs or pins 230 that extend downward from the input element 204 and that are received in corresponding channels formed in the base plate 206. In the illustrated embodiment, the base plate channels are defined by opposed prongs 232 that extend upward from the base plate 206 and receive the tabs 230 therebetween. The prongs 232 are positioned on opposing sides of the tabs 230, or on opposing sides of ridges formed on the tabs, in both the X and Y directions, such that the input element 204 is maintained in a fixed X, Y position relative to the base plate 206. It will be appreciated that the coupling mechanism 228 can be reversed, such that the tabs 230 extend from the base plate and the prongs 232 extend from the input element 204.

As evident from the foregoing, the stabilizing system 200 provides a silent and smooth click/tap feeling for a user of the input element 204 but reducing overall tolerance and preventing collisions between components of the system. The system does not require grease, and thus there is no smearing or quality issues. Also, by reducing the Z direction profile of the connection mechanism, the travel of the input element 204 can be reduced and, since the seesaw effect is prevented, the input element 204 can be depressed flatly without corner contact with the base plate 206.

The stabilizer bars, hooks, base plate, input element, spring tabs, and the various other components described herein can be formed from various materials known in the art, including metals, plastics, steel, resin, etc. and combinations thereof.

The various embodiments and features disclosed herein can be used in combination with one another. For example, the lower connection mechanism of FIG. 2D can be used with the upper connection mechanism of FIG. 5D, and the upper connection mechanism of FIG. 2D can be used with the lower connection mechanism of FIG. 5D. By way of further example, an input element can be stabilized simultaneously by one or more stabilization systems of the type shown in FIG. 2D and one or more stabilization systems of the type shown in FIG. 5D.

It will be appreciated that the upper and lower connection mechanisms can be reversed in any of the embodiments disclosed herein. For example, hooks 210 of the type shown in FIG. 3B can be provided on the underside of the input element 204 instead of or in addition to the hooks 208. Likewise, hooks 208 of the type shown in FIG. 3C can be provided on the base plate 206 instead of or in addition to the hooks 210.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A stabilizing system in an input device having a base plate and an input element, the system comprising:
a stabilizer bar having an elongate central portion and first and second leg portions extending from opposed ends of the central portion, the stabilizer bar being disposed beneath the input element;
a first lower hook extending upwards from the base plate having a first cut-out in which the first leg portion of the stabilizer bar is slidably received;
a second lower hook extending upwards from the base plate having a second cut-out in which the second leg portion of the stabilizer bar is slidably received;
wherein the stabilizer bar is configured to squeeze the first and second leg portions into engagement with the first and second cut-outs.

2. The system of claim 1, wherein the first cut-out is a section of a circle and the second cut-out is a section of a circle.

3. The system of claim 1, wherein the first and second cut-outs are semi-circular.

4. The system of claim 1, wherein the first and second cut-outs have a radius that is substantially equal to a radius of the stabilizer bar.

5. The system of claim 1, wherein:
the first lower hook comprises a first rectangular body portion and the first cut-out is formed in an edge of the first rectangular body portion; and
the second lower hook comprises a second rectangular body portion and the second cut-out is formed in an edge of the second rectangular body portion.

6. The system of claim 5, wherein the rectangular body portions of the first and second lower hooks extend parallel to a longitudinal axis of the central portion of the stabilizer bar.

7. The system of claim 5, wherein the rectangular body portions of the first and second lower hooks are formed integrally with the base plate.

8. The system of claim 5, wherein the rectangular body portions of the first and second lower hooks are formed by bending a portion of the base plate.

9. The system of claim 1, wherein the first and second leg portions are configured to slide within the first and second cut-outs in an X direction or a Y direction when the input element is translated in a Z direction.

10. The system of claim 1, wherein the first and second leg portions extend perpendicular to the central portion.

11. The system of claim 1, wherein the stabilizer bar includes first and second foot portions extending obliquely from the first and second leg portions, respectively.

12. The system of claim 1, further comprising a first upper hook extending downwards from the input element having a third cut-out in which the central portion of the stabilizer bar is rotatably received.

13. The system of claim 12, further comprising a second upper hook extending downwards from the input element having a fourth cut-out in which the central portion of the stabilizer bar is rotatably received.

14. The system of claim 12, further comprising a spring tab configured to urge the central portion of the stabilizer bar into engagement with the third cut-out.

15. The system of claim 1, wherein the input element is any of a clickable touchpad housing, a keyboard key, and a button.

16. The system of claim 1, further comprising a coupling mechanism configured to maintain the input element in a fixed X and Y position relative to the base plate and allow the input element to move towards and away from the base plate in a Z direction.

17. A mobile device, comprising:
an input device having an input element and a base plate; and
the stabilizing system of claim 1 coupled to said input device.

18. The mobile device of claim 17, wherein the mobile device is a laptop computer system.

19. A laptop computer system, comprising:
a plurality of stabilizing systems coupled between a clickable touchpad housing and a base plate, each stabilizing system comprising:
a stabilizer bar having an elongate central portion and first and second leg portions extending from opposed ends of the central portion;
a first lower hook extending upwards from the base plate having a first cut-out in which the first leg portion of the stabilizer bar is slidably received;
a second lower hook extending upwards from the base plate having a second cut-out in which the second leg portion of the stabilizer bar is slidably received, the stabilizer bar being configured to squeeze the first and second leg portions into engagement with the first and second cut-outs;
a first upper hook extending downwards from the housing having a third cut-out in which the central portion of the stabilizer bar is rotatably received;
a first spring tab configured to urge the central portion of the stabilizer bar into engagement with the third cut-out;
a second upper hook extending downwards from the housing having a fourth cut-out in which the central portion of the stabilizer bar is rotatably received; and
a second spring tab configured to urge the central portion of the stabilizer bar into engagement with the fourth cut-out.

20. A method of actuating an input device having a base plate, an input element, and a stabilizer bar, comprising:
depressing the input element;
during said depressing, rotating a central portion of the stabilizer bar within a semi-circular cut-out formed in an upper hook that extends down from the bottom of the input element; and
during said rotating, sliding first and second leg portions of the stabilizer bar within respective first and second semi-circular cut-outs formed in respective first and second lower hooks extending up from the base plate, the first and second leg portions being biased into engagement with the first and second cut-outs.
